(19) United States
(12) Patent Application Publication
(10) Pub. No.: US 2014/0337140 A1
(43) Pub. Date: Nov. 13, 2014

(54) Method and system for providing individually-tailored advertising analysis and motivation based on a user's personal financial management data

(71) Applicant: MoneyDesktop, Inc., Provo, UT (US)

(72) Inventor: John Ryan Caldwell, Provo, UT (US)

(73) Assignee: MoneyDesktop, Inc., Provo, UT (US)

(21) Appl. No.: 13/986,529

(22) Filed: May 13, 2013

(51) Int. Cl. G06Q 30/02

(52) U.S. Cl. CPC G06Q 30/0269
USPC 705/14.66

(57) ABSTRACT

An advertising engine is used to compare a user's current financial transaction with offerings from a variety of advertisers. This comparison is made from the user's personal financial management data. The user is informed of benefits to the user from taking advantage of an advertisement. The user can be electronically assisted in taking advantage of the advertisement.

### BACKGROUND

In the prior art, much advertising was either non-targeted or only vaguely targeted toward the users that it reached. For example, if a user searched for a particular item on the Internet, such as “North Face down jacket”, then for the next week or two when that user brings up an internet website, the user is also presented with advertisements from vendors of the product, in this case North Face down jacket. But the advertisements were in no way intelligently or individually tailored to a particular user's past conduct or actual needs based on actual data about the user's financial life.

U.S. Pat. No. 8,260,665 entitled “System and method of providing targeted advertisements from subscribers of directory services” matches users with advertisers based on a user's online and physical activities. For example, an advertisement for the Ford dealer will come up on the user's phone as the user drives past the Ford dealer's physical location.

U.S. Pat. No. 8,249,931 entitled “System for selectively communicating promotional information to a person” discloses an interactive system in accordance with the invention identifies, measures and tracks consumer exposure to a number of different advertisements or promotional segments and exposes consumers to several different advertisements. The system simultaneously identifies and measures viewer response and the number of consumers viewing different advertisements, while displaying different selected advertisements for viewing by the consumer.

U.S. Pat. No. 8,098,881 entitled “Advertisement insertion systems and methods for digital cameras based on object recognition” discloses an image capture system captures a visible image as a digital image. The object recognition system recognizes visible objects in the digital image. The advertisement insertion system inserts an advertising-related image into the digital image in response to a visible object in the digital image that was recognized.

U.S. Pat. No. 7,966,216 entitled “Method and system to identify and target consumers based on their spending behavior with respect to supplementary income” discloses a system and method for providing consumers marketing devices based on their use of supplementary income includes obtaining consumer financial data associated with a given “consumer” from one or more sources (such as a PFM system). At least part of the consumer financial data is then analyzed to determine if the given consumer typically receives supplementary income and, if so, how the consumer typically treats any supplementary income received. A supplementary income profile is then created for the given consumer. Data representing the supplementary income profile for the given consumer is then stored and at least part of the data representing the supplementary income profile for the given consumer is provided to one or more product marketers. One or more product marketers then provide a marketing device to the given consumer. The marketing device itself, and/or the time when the marketing device is provided to the given consumer, and/or the terms of the marketing device, is/are based, at least in part, on the data representing the supplementary income profile for the given consumer provided to one or more product marketers and analysis of the data representing the supplementary income profile for the given consumer performed by the product marketers.

U.S. Pat. No. 7,853,475 entitled “Intelligent advertising based on mobile content” discloses a method that can include identifying a context associated with a communication sent to or received by a remote unit belonging to the user group of remote units. The method also determines whether the identified context is associated with one or more advertisements by querying correlation data to identify advertisements having context that correlates to the identified context. Context may be determined by looking at terms/words used.

U.S. Pat. No. 6,847,969 entitled “Method and system for providing personalized online services and advertisements in public spaces” discloses an invention that provides advertisers the opportunity to directly engage actual and potential user-consumers with selected advertising or marketing content based on each user's profile and usage history.

U.S. Published Patent Application Document No. 20130110637 entitled “STRATEGICALLY TIMED DELIVERY OF ADVERTISEMENTS OR ELECTRONIC COUPONS TO A MOBILE DEVICE IN A MOBILE NETWORK” discloses an intelligent mobile advertising facilitates advertisement, promotional content, and/or coupons targeted by content consumption, application use, device parameters/settings/state, user identified, user status, time, or timing characteristics of mobile activity.

U.S. Published Patent Application Document No. 20120221413 entitled “INTELLIGENT PRESENTATION OF ADVERTISING WITH NAVIGATION” discloses a system with a controller (220) configured to control the operations of a wireless communication device; and an intelligent advertising module (290) configured to: run a navigation application including an inputted destination; provide advertising content on a display (240), based on a simulated route to the destination; and filter the advertising content based on highlighting business establishments in proximity to a same side of a street as the wireless communication device will travel on

U.S. Published Patent Application Document No. 20120265587 entitled “INTERACTIVE MARKING SYSTEM” discloses a computer-implemented method of creating a targeted marketing campaign for distribution to a plurality of end-users of public network accessible financial management service, comprising: selecting a target audience of end-users based on one or more of the demographic attributes, prior purchase attributes and prior response attributes to interactive marketing communications of end-users of the on-line financial management service; constructing a two-way marketing communication, displayable to users of the public network accessible financial management service, comprising a sequence of interview questions presented to an end-user in combination with an offer for a product or service presented in connection with the interview; and sending the communication over a public network to end-users within the target audience.

U.S. Published Patent Application Document No. 20110153413 entitled “Method and System for Intelligent Targeting of Advertisements” discloses a method for targeting advertisements to users of a social network, the method comprising: managing and indexing plurality of users data, profiles, connections and advertisements of the social network; receiving a request for an advertisement to be provided to a user(s) of the social network; accessing one or more advertisements, each advertisement comprising targeting criteria; for each of the accessed advertisements, applying the targeting criteria of the advertisement to user data and profile(s) for the user in the social network to determine whether the advertisement is a prospective for targeting to the user; routing and linking advertisement(s) for matching advertisement(s) related targeting criteria keywords with keywords of other connected one or more user(s)' data and profile(s) of the social network, to determine whether the advertisement is a prospective for targeting to the user; selecting an advertisement from the prospective advertisements determined for the user; and sending the selected advertisement to the user.

U.S. Published Patent Application Document No. 20090307072 entitled “Apparatus and Method for Managing Bank Account Services, Advertisement Delivery and Reward Points” discloses a system to securely and effectively control, process and manage financial services, targeted advertisement delivery, multiple account cards and reward points comprising a web portal or financial institution internet banking portal, offering financial services comprising a secure and effective on-line apparatus and method to manage bank account services, reward points, account cards and advertisement by matching users with advertisers wherein accurate information, such as current personally identifiable financial and transactional information as well as on-line behavioral data, is employed by means to securely process, control and manage financial information located within the premises of the financial institution providing the financial services as one of the criteria for matching advertisers with users.

U.S. Published Patent Application Document No. 20030061132 entitled “System and method for categorizing, aggregating and analyzing payment transactions data” Discloses a system that uses processed payment transaction records of consumer and business payers that received into a multi-dimensional networked data mart from databases originating from a multitude of financial institutions and payment processors. A post-processor linked to the data mart assigns all such transaction records with universal consumer and business expenditure categories used for payer financial management. Post-processed payment transaction records are indexed in the data mart by time, geography, and the universal consumer and business expenditure categories. Mathematical and analytical tools are applied to aggregated payment transaction records according to geographic, topographical, meteorological, chronological, demographic and other parameters. End users interact electronically with the data mart to view, create, synthesize and receive post-processed payment data for economic, investment, business, and marketing analysis.

### SUMMARY

Personal Financial Management (“PFM”) refers generally to computer software tools and utilities that assist a user in money tracking, and budgeting, and may include but is not necessarily limited to permitting a user to view account activity, budget future expenses and savings, accomplish electronic bill pay, etc. PFM software can be run on a user's computing device (such as desktop computer, laptop computer, notebook computer, tablet computer, smart phone, or other device with computing power), or on hardware operated by a PFM provider, with data displayed locally on the user's computing device.

PFM data can contain a wealth of information about the user, including the user's employer, job title, income, tax information, residence location, residence type, mortgage information, automobile information, auto loan information, bank statements, credit card statements, consumer debt information, other loan information, information about spending habits, travel information, etc.

PFM data can be used not only to target the user with advertisements relevant to the user's personal situation and habits, it can also be used to analyze, compute and/or compare the user's present situation or past activity with an advertisement offering and explain to the user why taking advantage of the advertised product or service is personally advantageous to the user. For example, if the user has an auto loan, the user's auto loan could be analyzed in comparison with an advertisement offering for auto loans and the computer could be informed, “Dear User, you can save $38 per month by switching your auto loan to ABC Bank.”

By providing individually-tailored advertising analysis and motivation based on a user's PFM data, the consumer directly benefits by learning of offerings which are advantageous to that particular consumer. And the advertiser benefits by being able to directly target consumers who can be shown a calculable benefit, thereby increasing advertising response and ensuring that advertising dollars are spent on reaching consumers who will likely have an interest in the advertised product or service.

In a personal financial management PFM environment, a user's PFM data can be accessed to determine the types of financial transactions the user is or has engaged in (mortgage, auto loan, credit card balances, cell phone contract, past purchases at particular retailers, travel, etc.). This step can be referred to as ACCESS USER DATA.

For each such transaction found in a user's PFM data, analyze/compare the user's transaction details with competitive offerings made available by various advertisers. For example, compare the interest rate on the user's auto loan with the interest rate on auto loans offered by various financial institutions. This step can be referred to as COMPARE TO ADVERTISERS' OFFERINGS.

If an advertiser offers better terms for its product/services than the user appears to be receiving, then calculate or determine the potential advantage to the user of switching his/her transaction to the advertiser in question. This step can be referred to as DETERMINE POTENTIAL BENEFIT.

Inform the user of the potential advantage to be gained by switching to the selected advertiser. For example, display a message such as: “User, you can save $38 per month by switching your auto loan to ABC Bank. To do so click HERE.” This step can be referred to as INFORM CONSUMER/REQUEST SWITCH. Or they can be two separate steps.

If the user desires to take advantage of the advertisement offering, then electronically assist the user in switching his/her selected transaction to the advertiser, if the user consents to such a switch. This step can be referred to as ELECTRONICALLY ASSIST.

When such a system or method is implemented, advertising response will rise and consumers will financially benefit from savings derived on offers directly related to their personal financial situations.

Various other objects, features and advantages of the invention will become apparent to persons of ordinary skill in the art upon reading this complete specification in view of the appended drawings.

### BRIEF DESCRIPTION OF THE DRAWINGS

FIG. 1 depicts an example system according to one embodiment of the invention.

FIG. 2 depicts an example method according to one embodiment of the invention.

### DETAILED DESCRIPTION

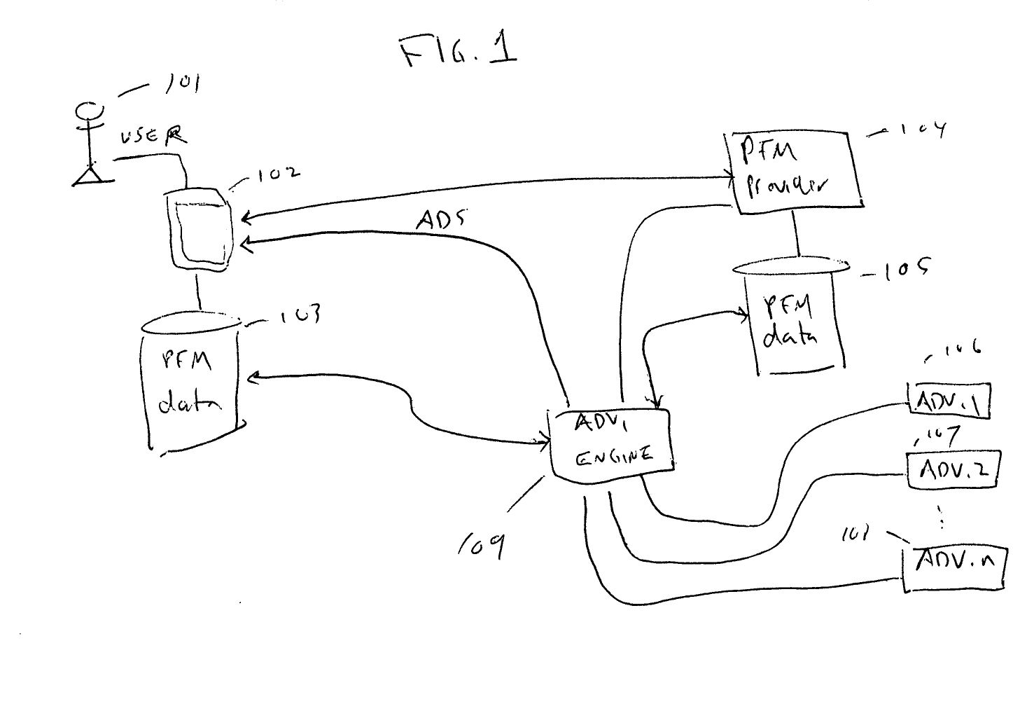

Referring to FIG. 1 an example system according to one embodiment of the invention is depicted. In the example, a user 101 has a computing device 102. The user utilizes a PFM software package from a PFM provider 104. The PFM package may store the user's PFM data on a database 103 local to the user's computing device 102. Or the PFM package may store the user's PFM data at a remote database 105. An interested party such as the PFM provider or an advertising agency or advertising coordinator can utilize a Advertising Engine 109, to receive advertisements and offers from Advertister1 106, Advertiser2 107, . . . etc. up to AdvertiserN 108.

Both the PFM package and the Advertising Engine can be constructed as computer software packages running on digital computers that include dynamic memory, static memory, computer-readable storage media, input means, output means, display means, communication means, and/or additional structures. Alternatively, other types of computing structures could be used, such as quantum computers, nanocomputers, biological computers, etc. Any devices capable to carrying out the communications, display, computation and comparison functions needed to implement the inventive concept can be considered computing devices.

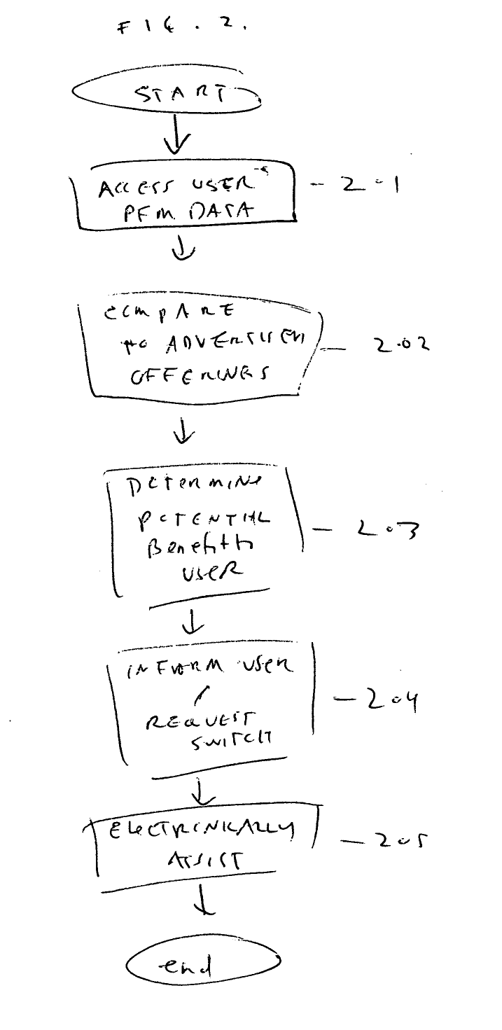

Referring to FIG. 2, an example method according to one embodiment of the invention is depicted. According to the example, in a personal financial management PFM environment, a user's PFM data can be accessed to determine the types of financial transactions the user is or has engaged in. Example transactions can include home mortgage, auto loan, credit card balances, cell phone contract, past purchases at particular retailers, travel, cell phone contract, cable TV or satellite TV subscription, investment activity, etc. This step can be referred to as ACCESS USER PFM DATA 201. This step can be performed by an Advertising Engine.

For at least some transactions found in a user's PFM data, analyze and or compare the user's transaction details with competitive offerings made available by various advertisers. For example, compare the interest rate on the user's auto loan with the interest rate on auto loans offered by various financial institutions. Compare the interest rate of the user's mortgage with rates offered by advertising banks. Look for sales at retailers where the user has shopped. Look for vacation packages which may suit the user's interests, etc. This step can be referred to as COMPARE TO ADVERTISERS' OFFERINGS 202.

If an advertiser offers better terms for its product/services than the user appears to be receiving, then calculate or determine the potential advantage to the user of switching his/her transaction to the advertiser in question. The benefit can be calculated as a one time or periodic benefit, or can be expressed in other terms. For example, the Advertising Engine can calculate that the user's monthly mortgage payment would drop by a certain amount if the user switched his/her mortgage to an advertiser. Or the Advertising Engine can calculate that the user would pay off his/her mortgage early with the selected advertiser. Or the Advertising Engine can calculate that the user will save a sum total of $x by switching to the advertiser. Or other benefits can be calculated. This step can be referred to as DETERMINE POTENTIAL BENEFIT 203.

Inform the user of the potential advantage to be gained by switching to the selected advertiser. For example, display a message such as: “User, you can save $38 per month by switching your auto loan to ABC Bank. To do so click HERE.” This step can be referred to as INFORM CONSUMER/REQUEST SWITCH 204. Or this can be broken down into two separate steps.

If the user desires to take advantage of the advertisement offering, then electronically assist the user in doing so, if the user consents. This step can be referred to as ELECTRONICALLY ASSIST 205.

When such a system or method is implemented, advertising response will rise and consumers will financially benefit from savings derived on offers directly related to their personal financial situations.

The invention has many uses across many industries, but is discussed herein with regard to a specific example of personal financial management software. Such specific discussion should not be considered to be limiting of the interpretation of the scope of the claims. Those skilled in the art will appreciate that variations and modifications may be made without departing from the principles of the invention as herein illustrated, described, and claimed. The present invention may be embodied in other specific forms without departing from its spirit or essential characteristics. All described embodiments are to be considered in all respects as only illustrative, and not restrictive. The scope of the invention is, therefore, indicated by the appended claims, rather than by the foregoing description. All changes which come within the meaning and range of equivalency of the claims are to be embraced within their scope.

1. In a computing environment where a user has at least one computing device and a Personal Financial Management (PFM) Provider has at least one computing device, and the user utilizes a PFM package and has PFM data, and the PFM data is kept on a database, and an Advertising Engine operating on a computing device has access to the PFM data and to advertisements and offerings from a variety of advertisers, a method comprising the following steps:
a. the Advertising Engine operating on a computing device accessing the user's PFM data on a database,
b. the Advertising Engine operating on a computing device accessing advertisements and offerings from a variety of advertisers,
c. the Advertising Engine operating on a computing device comparing transactions in said user's PFM data to advertisements and offerings from a variety of advertisers,
d. for at least one user transaction found in the user's PFM data and at least one advertisement or offering, the Advertising Engine operating on a computing device determining or calculating a potential benefit to the user from taking advantage of such advertisement or offering,
e. informing the user of such potential benefit on the user's computing device, and
f. on the user's computing device, requesting the user's consent to take advantage of the selected advertisement or offering in order to enjoy the potential benefit.

2. A method as recited in claim 1 further comprising the step:
g. electronically assisting the user in taking advantage of such advertisement or offering.

3. In a PFM environment, a method for delivering advertisements to a user comprising the steps of:
using computing device to access a user's PFM data stored on a database,
using a computing device to access a plurality of advertisements,
using a computing device to perform a comparison of advertisements with transactions in said user's PFM database and determine a potential benefit to the user from taking advantage of a selected advertisemetn,
using a computing device to inform the user of said potential benefit.

4. A method as recited in claim 3 further comprising the step of using a computing device to obtain a user's consent to take advantage of the selected advertisement.

5. A method as recited in claim 4 further comprising the step of electronically assisting the user in taking advantage of said selected advertisement.
